(19) United States
(12) Patent Application Publication
(10) Pub. No.: US 2026/0340650 A1
(43) Pub. Date: Oct. 29, 2026

(54) AI Agents for Supply Chain Code of Conduct Compliance

(71) Applicants: Gennaro Anthony Cuomo, Raleigh, NC (US); Shyam Adivi, Apex, NC (US); Palghat Krishnan Sridhar, Morrisville, NC (US); Sai Nidamarty, Cary, NC (US)

(72) Inventors: Gennaro Anthony Cuomo, Raleigh, NC (US); Shyam Adivi, Apex, NC (US); Palghat Krishnan Sridhar, Morrisville, NC (US); Sai Nidamarty, Cary, NC (US)

(73) Assignee: Chainyard Supplier Management Inc, Morrisville, NC (US)

(21) Appl. No.: 19/186,979

(22) Filed: Apr. 23, 2025

(51) Int. Cl. G06Q 30/018

(52) U.S. Cl. CPC G06Q 30/018

(57) ABSTRACT

A system for automated supplier Code of Conduct (CoC) compliance assessment is disclosed. The system dynamically discovers, extracts, and analyzes supplier CoC policies using retrieval-augmented generation (RAG) to ensure assessments are based on real-world documents. It employs large language model (LLM)-generated AI agents instantiated in real time, each assigned specific roles and tasks corresponding to compliance disciplines such as labor rights, environmental practices, and anti-corruption. The agents operate in structured squads, executing tasks in defined sequences with self-reflection to refine outputs. Compliance alignment is measured using similarity scoring, and the system triggers automated actions—such as alerts or corrective requests—when policy gaps are detected. A persistent compliance store retains all results for auditability and ongoing governance. The invention enables scalable, real-time, and transparent compliance monitoring with minimal human intervention, improving accuracy, efficiency, and supplier accountability in supply chain operations.

### BACKGROUND

### Field of the Invention

The present invention relates to the application of artificial intelligence in supply chain compliance management, specifically in assessing supplier adherence to corporate codes of conduct, regulatory standards, and ethical guidelines within procurement and supply chain operations.

### Description of the Related Art

Ensuring supplier adherence to corporate codes of conduct, regulatory requirements, and ethical standards is a fundamental challenge across supply chains of all sizes. While large corporate buyers, managing thousands of suppliers across multiple industries and jurisdictions, face this challenge at scale, even smaller organizations lack automated governance mechanisms to efficiently monitor and enforce compliance. Similarly, suppliers themselves must demonstrate adherence to buyer expectations, industry regulations, and sustainability commitments, often without streamlined tools to manage and communicate their compliance status.

Traditional compliance assessment methods rely on manual processes, which are inefficient, costly, and prone to inconsistencies. Buyers frequently request self-assessments and audits from suppliers, requiring them to complete time-consuming questionnaires that may result in selective, outdated, or incomplete disclosures. This approach places a burden on both buyers and suppliers, leading to redundant efforts, delays, and potential inaccuracies in compliance reporting.

To supplement direct outreach, organizations often turn to third-party compliance databases, such as those provided by Moody's, Dun & Bradstreet, and EcoVadis. While these services aggregate compliance data, they may not provide real-time updates, lack coverage for smaller or regionally focused suppliers, and fail to align with a buyer's specific compliance requirements. Additionally, these services can be expensive, making them inaccessible to many organizations, particularly smaller buyers and suppliers. Suppliers, in turn, may struggle to ensure their information is accurately reflected across multiple platforms, leading to inconsistencies in compliance visibility.

Publicly available supplier codes of conduct serve as a valuable but underutilized resource, as they outline commitments to ethical labor practices, environmental sustainability, and regulatory compliance. These documents are often posted on company websites, but discovering, extracting, and analyzing them remains a manual, resource-intensive process. Without efficient mechanisms to incorporate this information into governance frameworks, organizations face gaps in due diligence, increased regulatory exposure, and inefficiencies in supplier management.

### Comparison to Related Art

Prior approaches to compliance automation in supply chain operations have largely centered around centralized databases, manual audits, and structured questionnaire-based evaluations. U.S. Pat. No. 11,386,296 B2 discloses an augmented intelligence system wherein cognitive agents execute predefined skills under the direction of a cognitive orchestration platform to ensure adherence to technical or business policies. While it introduces agent orchestration and compliance functions in enterprise contexts, it lacks the capacity for real-time document discovery, retrieval-augmented analysis, or dynamic instantiation of agents from mission-specific compliance objectives. Moreover, it does not address supply chain contexts or the extraction and evaluation of publicly posted supplier codes of conduct.

WO2021084510A1 outlines a generalized framework for configuring and executing artificial intelligence agents using a modular, workflow-driven environment. The system allows agent chaining and data flow control across tasks, offering flexibility in AI system construction. However, this design assumes static user-defined workflows and does not employ self-reflective agents, retrieval-augmented generation, or automated similarity-based scoring to assess compliance. It remains agnostic to regulatory content and lacks specialization for supply chain governance or ESG enforcement.

Smolnig et al. (“Compliance Cards: Automated EU AI Act Compliance Analyses Amidst a Complex AI Supply Chain,” arXiv, 2024) describe a method for metadata-based compliance prediction across AI supply chains. While this research aligns with broader goals of compliance automation, it targets system-level conformance to the EU AI Act, using model metadata and documentation artifacts rather than evaluating human-readable supplier policy documents. It also lacks the use of LLM-generated agents, similarity analysis, or structured task orchestration.

Collectively, these systems represent important progress in AI-based orchestration and regulatory automation. However, they do not provide a unified, scalable solution for autonomous supplier compliance analysis grounded in publicly available documents. The present invention addresses this need by dynamically generating policy-specific AI agents, orchestrated in structured squads, to autonomously retrieve, analyze, and compare supplier codes of conduct against buyer-defined requirements using retrieval-augmented generation, similarity scoring, and event-triggered workflows.

### SUMMARY OF THE INVENTION

The present invention provides an AI-driven system for automating supplier Code of Conduct (CoC) compliance assessments, addressing inefficiencies in traditional compliance methods. By leveraging AI-powered agents, the system autonomously discovers, extracts, analyzes, and compares supplier CoC policies and compliance reports to assess alignment with corporate, regulatory, and ethical requirements at scale.

Unlike conventional methods that rely on self-reported data, third-party compliance databases, or manual reviews, this system introduces a scalable and adaptable AI framework. It dynamically retrieves CoC policies from public sources or user-provided documents, using retrieval-augmented generation (RAG) to ensure assessments are grounded in factual data. These policies are analyzed across key compliance areas—including labor rights, environmental sustainability, and anti-corruption—without requiring direct supplier engagement unless discrepancies are identified.

A key innovation is the system's ability to dynamically instantiate AI agents and tasks based on the compliance mission. AI agents are assigned specific roles and objectives, working in structured squads that ensure compliance evaluations follow a logical sequence of discovery, validation, analysis, and reporting. Each agent autonomously extracts relevant policy information, conducts structured comparisons against buyer requirements, and generates similarity scores with justifications, improving transparency in compliance assessments.

Beyond analysis, the system automates compliance actions based on its findings. If a supplier's CoC lacks alignment with requirements, it can trigger alerts or corrective action requests, streamlining engagement while reducing manual effort.

Additionally, the system maintains an auditable compliance record, structuring extracted policies, similarity scores, and reports for ongoing governance. Unlike static compliance databases, this system continuously adapts as new data is discovered, ensuring real-time, scalable compliance monitoring while improving supplier accountability and regulatory adherence.

### BRIEF DESCRIPTION OF THE DRAWINGS

FIG. 1—System Architecture

Illustrates the overall system structure, including compliance configuration, AI orchestration, support agents, dynamically instantiated policy agents, and compliance outputs with event triggers.

FIG. 2—AI Orchestration & Control

Depicts squad-based execution, where AI agents are dynamically created, assigned tasks, execute autonomously with self-reflection, and track execution for auditability.

FIG. 3—Overview of Agents & Tasks

Shows AI squads performing discovery, validation, policy analysis, compliance scoring, and event-triggered reporting within structured task execution.

FIG. 4—Dynamic AI Agent & Task Instantiation

Illustrates how LLM-generated AI agents and tasks are instantiated dynamically based on compliance disciplines, ensuring policy-specific analysis and structured execution.

FIG. 5—Compliance Outputs & Events

Displays how compliance-related documents, extracted policies, similarity assessments, and structured reports are stored, with automated event triggers for compliance actions.

FIG. 6—Sample Policy Comparison Summary

Provides an example compliance assessment comparing Amazon and UPS, highlighting policy similarities, differences, and computed similarity scores across key compliance areas.

### DETAILED DESCRIPTION OF THE INVENTION

### System Overview

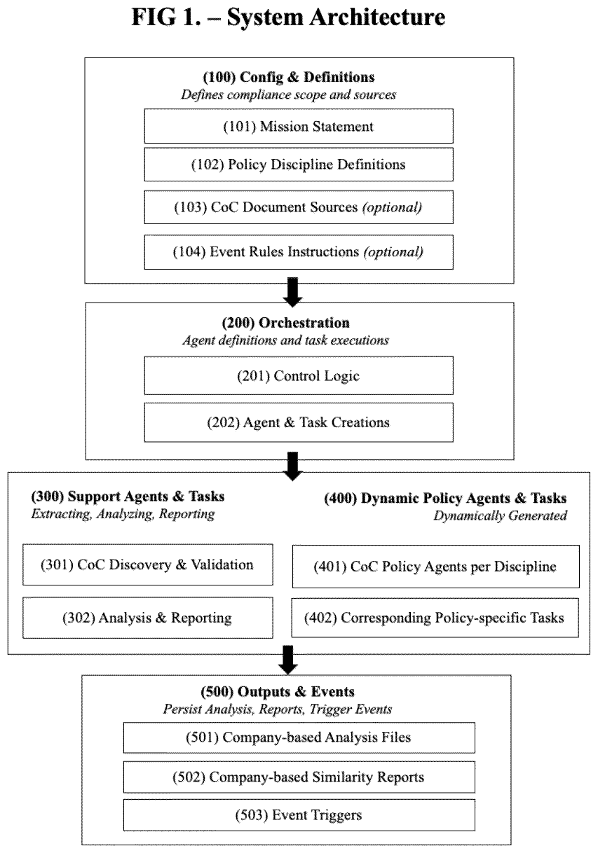

The disclosed system enables fully automated, end-to-end supplier Code of Conduct (CoC) compliance assessments with minimal input. As illustrated in FIG. 1, it dynamically generates mission-specific AI agents (202) that autonomously discover (301), validate (302), and analyze CoC policies across predefined disciplines (401, 402). The Orchestration Layer (200) governs execution, while Config & Definitions (100) establish assessment parameters (101, 102). Compliance outputs (500) include structured reports (501, 502) and automated event triggers (503). This architecture builds on existing agentic frameworks, enabling straight-through automation, eliminating manual intervention and ensuring scalable, real-time compliance assessments tailored to buyer-defined requirements.

### Configuration and Definitions

The system operates based on configurable parameters defining assessment scope and policy disciplines. The Mission Statement (101) specifies user-defined objectives guiding compliance evaluations. For example, a mission my task agents to “identify, validate, extract, and analyze corporate Supplier Codes of Conduct and related policies to enable accurate comparisons across suppliers, support compliance evaluations, and drive informed procurement decisions.”

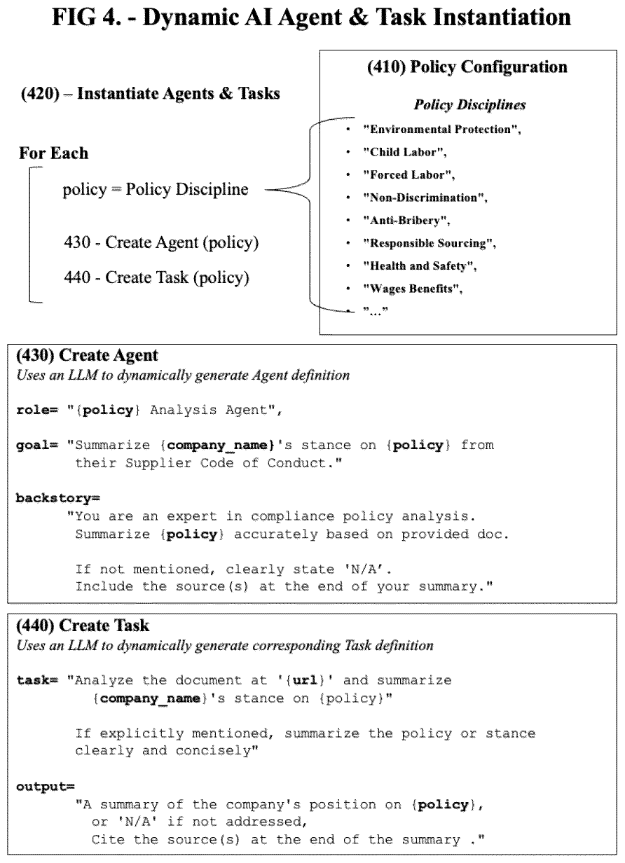

The Policy Discipline Definitions (102), detailed in FIG. 4, Element 410, outline key compliance areas, including environmental protection, child labor, forced labor, anti-bribery, and data privacy. The system can retrieve CoC policies from CoC Document Sources (103)—specific URLs or documents manually provided by users—but this step is optional. If no sources are seeded, the system's AI agents autonomously discover supplier CoCs through web searches and retrieval-augmented techniques. Additionally, an optional event instruction file (104) provides directives to an agent, enabling it to trigger compliance-related actions. These instructions may include sending alerts, requesting additional documentation, or escalating compliance concerns based on similarity scores. All that is required are simple natural language inputs—no programming, custom workflows, or extensive configuration is needed.

### AI Orchestration and Agent Control

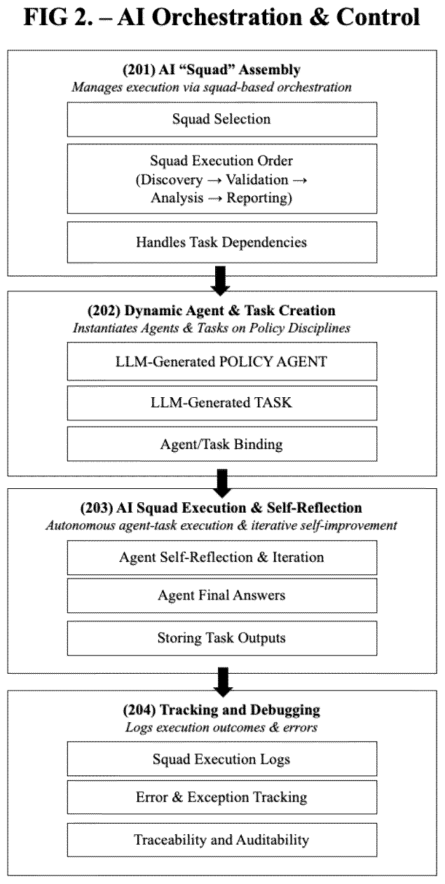

The system employs a squad-based AI orchestration framework (FIG. 2) to manage structured execution flow, ensuring efficient compliance assessments. The AI Squad Assembly (201) organizes dynamically instantiated agents into structured groups, defining an execution sequence of Discovery→Validation→Analysis→Reporting while managing dependencies.

The Dynamic Agent & Task Creation Module (202) uses an LLM to generate policy-specific AI agents and their corresponding tasks, binding them dynamically to ensure alignment with compliance objectives. Each LLM-generated Policy Agent specializes in evaluating a specific policy area, while similarly generated Tasks define execution parameters.

The AI Squad Execution & Self-Reflection Module (203) enables agents to autonomously iterate on outputs, refining their analysis before finalizing responses. Task results are stored for compliance reporting. The Tracking and Debugging Module (204) logs execution details, tracks errors, and ensures full traceability for auditability. This structured orchestration enables autonomous, scalable compliance assessments with minimal human oversight.

### Agents and Tasks

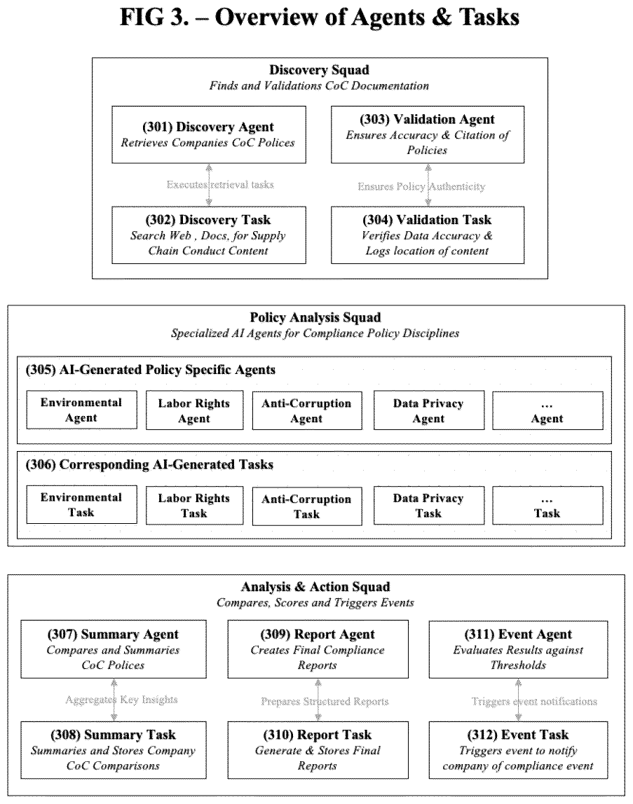

The system employs specialized squad-based AI agents (FIG. 3) to execute compliance tasks, ensuring structured and efficient policy evaluations.

The Discovery Squad identifies and validates supplier CoC policies. The Discovery Agent (301) retrieves CoC policies from public sources or provided documents, executing the Discovery Task (302), which searches websites, databases, and uploaded files. The Validation Agent (303) ensures the accuracy of extracted policies via the Validation Task (304), confirming citations and logging document sources.

The Policy Analysis Squad consists of AI-Generated Policy-Specific Agents & Tasks (305, 306), dynamically instantiated to assess compliance across different policy disciplines, which are described in detail below. The Policy-Specific Analysis Task (313) performs similarity scoring, comparing extracted policies against buyer requirements to identify alignment gaps.

The Analysis & Action Squad synthesizes findings and triggers compliance actions. The Summary Agent (307) consolidates CoC assessments through the Summary Task (308), while the Report Agent (309) generates structured reports via the Report Task (310). If compliance gaps are detected, the Event Agent (311) evaluates results against predefined thresholds and executes the Event Task (312), triggering alerts or corrective actions as needed.

### Dynamic AI Agent and Task Instantiation

The system dynamically generates AI agents and corresponding tasks using an LLM to instantiate mission-specific compliance roles in real time (FIG. 4). Guided by the Mission Statement (101) and Policy Discipline Definitions (102), the Policy Configuration Module (410) defines key compliance areas, such as child labor, anti-bribery, and environmental protection.

Using this configuration, the Agent Instantiation Module (420) dynamically generates support agents, each with a unique role, goal, and backstory tailored to its assigned compliance discipline. For example, an agent analyzing anti-bribery policies may be instantiated as:
Agent Definition (430):
Role: Anti-Bribery Analysis Agent
Goal: Summarize {company_name}'s stance on anti-bribery from their Supplier Code of Conduct.

Backstory: You are an expert in corporate compliance with a specialty on anti-bribery practices.

Each agent is assigned a dynamically generated policy-specific task through the Task Assignment Module (440). For example, a task corresponding to the above:
Task (440):
Definition: Analyze the document at {url} and summarize {company_name}'s stance on anti-bribery.
Output: A summary of the company's position on anti-bribery in 100 words or less, or ‘N/A’ if not addressed, citing source(s) at the end.

This dynamic instantiation ensures that only the necessary agents and tasks are created to execute the compliance mission efficiently, allowing scalable, targeted, and policy-specific analysis without manual intervention.

### Compliance Outputs and Event Triggers

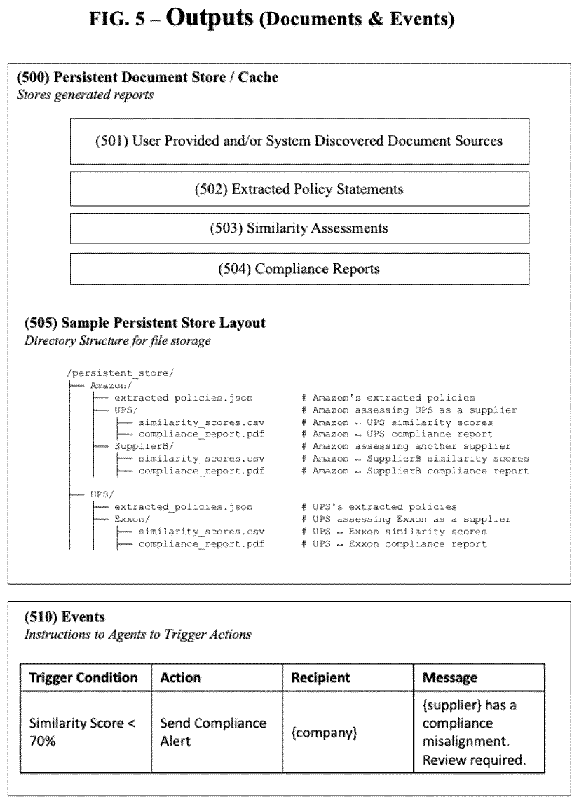

The system generates structured compliance reports and automates event-driven actions based on assessment results (FIG. 5). The Persistent Document Store (500) maintains all compliance-related documents, including extracted policies, assessments, and reports for auditing and future analysis.

The User-Provided and System-Discovered Document Sources (501) store the original supplier CoC policies, either manually uploaded or retrieved via AI discovery. These documents undergo Extracted Policy Statement Processing (502) to convert them into structured compliance data. The Similarity Assessments Module (503) performs comparative analysis, scoring supplier policies against buyer expectations and identifying compliance gaps.

Finalized Compliance Reports (504) summarize alignment, differences, and recommendations for each supplier. The Sample Persistent Store Layout (505) structures data hierarchically, with top-level directories for each buyer (e.g., Amazon), and subdirectories for each assessed supplier, storing extracted policies, similarity scores, and reports.

The Event Trigger System (510) automates compliance actions based on assessment results. For example, if a similarity score (503) falls below a predefined threshold (e.g., 70%), the system triggers an alert to the buyer, notifying them of the supplier's misalignment. Actions may include sending compliance warnings, requesting additional documentation, or escalating reviews within procurement workflows.

This structured and event-driven approach ensures compliance assessments remain actionable, scalable, and seamlessly integrated into governance processes.

### Sample Comparative Policy Similarity Report

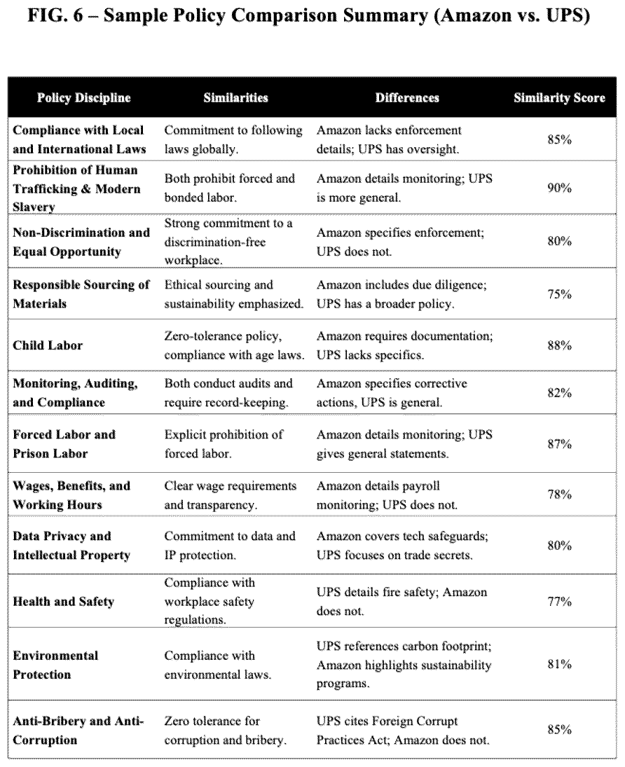

The system generates structured comparative policy similarity reports to highlight alignment and discrepancies between supplier and buyer policies (FIG. 6). Each report includes a similarity score (503), identifying where supplier policies align or deviate from buyer expectations across compliance disciplines. For example, an assessment of Amazon and UPS may show strong alignment in anti-bribery policies (85%), while UPS lacks detailed enforcement on wages and benefits (78%). These structured comparisons enable buyers to quickly assess compliance risks and trigger appropriate corrective actions.

### Advantages Over Prior Art

The present invention delivers significant advancements over existing compliance management systems:
Unlike traditional methods that depend on static databases and manual reviews, this system autonomously discovers and analyzes supplier Code of Conduct (CoC) policies in real time using retrieval-augmented generation (RAG). This ensures compliance evaluations are based on current, verifiable data rather than outdated or self-reported information.
Existing AI compliance tools often require predefined workflows or manual agent configuration. In contrast, this invention dynamically generates Large Language Model (LLM)-based agents, each assigned specific compliance roles and tasks at runtime. This dynamic instantiation allows policy-specific analysis to adapt flexibly to different compliance missions without programming effort.

A key technical contribution is the structured, squad-based orchestration of agents. These squads execute tasks in a defined sequence—discovery, validation, analysis, and reporting—with built-in self-reflection to refine results autonomously. Prior systems lack this level of autonomous, coordinated task execution.

Moreover, the system applies similarity scoring to quantify how closely supplier policies align with buyer requirements, triggering automated compliance actions when misalignments are detected. This integration of quantitative analysis with automated, event-driven governance is absent in prior solutions, which typically rely on static thresholds or manual intervention.

Finally, the invention provides a persistent compliance store, retaining extracted policies, similarity scores, and reports for full auditability and ongoing governance. This ensures transparency and traceability, which are often lacking in existing compliance systems.

In sum, the invention offers a scalable, adaptive, and autonomous compliance framework, advancing beyond static, manually configured, or semi-automated prior art.

### DEFINITION OF TERMS

Code of Conduct (CoC)—A formal document outlining a company's ethical, legal, and operational standards that suppliers are expected to follow.

Compliance Assessment-The process of evaluating a supplier's adherence to a buyer's Code of Conduct, regulatory standards, and policy requirements.

AI Agent—An autonomous computational entity with a defined role, goal, and backstory, responsible for executing specific compliance-related tasks.

Squad—A structured group of AI agents working collaboratively to perform compliance tasks in a coordinated, logical sequence. Examples include “Crews” as defined within the CrewAI framework, ensure proper task execution, dependency management, and iterative refinement.

LLM-Generated Agents—AI agents dynamically instantiated using a Large Language Model (LLM), where roles, goals, and tasks are assigned based on the compliance mission and discovered data.

LLM-Generated Task—A dynamically created compliance evaluation task, assigned to an AI agent based on policy-specific requirements, ensuring targeted analysis.

Self-Reflection—The ability of AI agents to iteratively review, refine, and improve their own outputs before finalizing compliance assessments.

Retrieval-Augmented Generation (RAG)—A method where AI agents retrieve real-world CoC documents and external data before analyzing content, ensuring factual accuracy.

Similarity Scoring—A quantitative measure comparing a supplier's policies to buyer requirements, highlighting alignment, gaps, and potential compliance risks.

Event Triggering—The automated process of initiating compliance-related actions, such as alerts, notifications, or corrective measures, based on similarity scores or detected policy gaps.

Policy-Specific Analysis—A focused evaluation of a supplier's compliance within predefined disciplines, such as labor rights, environmental impact, and anti-bribery.

Persistent Compliance Store—A structured database that retains extracted policies, similarity scores, reports, and event triggers for long-term auditability and governance tracking.

What is claimed is:

1. A system for automated assessment of supplier compliance with Codes of Conduct (CoC), comprising:
a retrieval module configured to obtain CoC policies from public sources or user-provided inputs;
a dynamic agent generation module configured to instantiate, at runtime, one or more AI agents, each assigned a compliance-related role and task;
a policy analysis module configured to compare retrieved CoC policies to predefined compliance criteria, and to generate similarity scores;
a refinement module configured to enable iterative improvement of compliance assessments by the AI agents; and
an action module configured to trigger compliance-related actions based on the assessment results.

2. The system of claim 1, wherein the AI agents are grouped into squads that perform tasks in a sequential manner, the squads comprising:
a discovery squad configured to retrieve and validate CoC policies;
a policy analysis squad configured to evaluate CoC policies across multiple compliance categories; and
an action squad configured to generate reports and trigger compliance actions based on predefined conditions.

3. The system of claim 1, wherein the AI agents are generated using a large language model (LLM) and are assigned:
a role defining a compliance function;
a goal specifying a policy analysis objective; and
a task specifying execution parameters and expected output.

4. The system of claim 1, wherein the policy analysis module generates a similarity score indicating the degree of alignment between a supplier's CoC policy and compliance criteria, and wherein the action module triggers a compliance action when the similarity score falls below a threshold.

5. The system of claim 1, wherein the retrieval module employs retrieval-augmented generation (RAG) to ground compliance assessments in externally sourced CoC policies.

6. The system of claim 1, further comprising a persistent data store configured to retain retrieved policies, similarity scores, and assessment reports for audit and tracking purposes.

7. The system of claim 2, wherein the AI agents perform self-reflection to refine outputs before finalizing assessments.

8. The system of claim 4, wherein the compliance actions include at least one of: generating an alert, issuing a corrective action request, or initiating a procurement system update.

9. The system of claim 1, wherein the action module triggers compliance actions based on conditions selected from: a similarity score threshold, missing policy elements, or detected regulatory misalignment.

10. The system of claim 3, wherein the AI agents operate within an agentic framework configured for real-time compliance evaluation.

11. The system of claim 1, wherein the predefined compliance criteria comprise one or more of: labor rights, environmental protection, anti-bribery policies, forced labor prohibitions, child labor restrictions, or data privacy standards.

12. A method for automated assessment of supplier compliance with Codes of Conduct (CoC), the method comprising:
retrieving CoC policies from public sources or user-provided inputs;
instantiating, at runtime, one or more AI agents, each assigned a compliance-related role and task;
comparing the retrieved CoC policies to predefined compliance criteria to generate similarity scores;
iteratively refining compliance assessments based on outputs from the AI agents; and
triggering compliance-related actions based on the similarity scores.

13. The method of claim 12, wherein the AI agents are grouped into squads that perform tasks in a sequential manner, the tasks comprising: retrieving and validating CoC policies; evaluating CoC policies across compliance categories; and generating reports and triggering compliance actions.

14. The method of claim 12, wherein the predefined compliance criteria comprise one or more of:
labor rights, environmental protection, anti-bribery policies, forced labor prohibitions, child labor restrictions, or data privacy standards.
